(19) United States
(12) Patent Application Publication
(10) Pub. No.: US 2009/0210313 A1
(43) Pub. Date: Aug. 20, 2009

(54) Method for environmentally-friendly shipping

(76) Inventors: James J. Winebrake, Pittsford, NY (US); James Joseph Corbett, JR., Newark, DE (US)

Correspondence Address: James J. Winebrake, 2 Babcock Farms Lane, Pittsford, NY, 14534, US

(21) Appl. No.: 12/070,405

(22) Filed: Feb. 19, 2008

(51) Int. Cl. G06Q 99/00

(52) U.S. Cl. 705/26

(57) ABSTRACT

A method for environmentally-friendly shipping including requesting a shipment of goods, identifying available shipping options, analyzing the available shipping options, presenting the available shipping options, selecting one of the available shipping options and shipping the shipment of goods via the selected available shipping option. The method also includes considering one or more environmental impact measures.

### CROSS-REFERENCES TO RELATED APPLICATIONS/PATENTS

This application is relates back to and claims the benefit of priority from U.S. Provisional Application for Patent filed on Feb. 21, 2007and entitled “Method and System for Environmentally-Friendly Shipping.”

### FIELD OF THE INVENTION

This invention generally relates to methods for shipping freight, products and goods, and particularly to methods for shipping freight and goods that allow a shipping decision authority to select a mode of shipment from a variety of shipping options.

### BACKGROUND AND DESCRIPTION OF THE PRIOR ART

It is known to ship goods, products and freight from one point to another (typically business-to-business or business-to-consumer) in various forms. Typical modes of freight transport are truck, airplanes, marine vessels, and train. These modes also comprise a variety of transportation technologies. For example, marine vessels may include large container ships, roll-on/roll-off ships, barges, tankers, and cargo vessels. Likewise, truck and rail technologies are used to move a diverse set of freight types in bulk, containerized, and smaller units. Shipping practices vary with customer needs and shipper constraints. In the United States, over 70% of the freight moved (as measured in tons) is moved by truck. Decisions on how to move goods are driven by two primary considerations; namely, economics and delivery time. Decisions on the frequency (whether and how often) with which to move goods depends upon inventory and consumption rates for freight, products and goods.

Conventional methods for shipping goods, however, suffer from one or more disadvantages. For example, conventional methods for shipping goods contribute to environmental problems, especially within the transportation sector. Greenhouse gases (such as carbon dioxide) emitted by the transportation sector threaten our climate, and local and regional pollutants (such as particulate matter, nitrogen oxides, and sulfur oxides) threaten human health and ecological systems. Transportation in the United States emits about 30% of all greenhouse gases and contributes to 60-70% or more of air quality problems in urban areas. Because the cheapest and quickest delivery methods are often the most environmentally-damaging, trends point toward increased environmental problems resulting from freight transportation based on conventional methods for shipping goods.

More particularly, conventional methods for shipping goods do not use environmental criteria in analyzing shipping options. This creates a bias towards shipping options that emphasize cost, reliability, and delivery time criteria at the expense of environmental quality. In addition, conventional methods for shipping goods do not identify and present environmentally-friendly shipping options to a shipping decision authority (“SDA”). This creates a limited selection of options and eliminates other options that are environmentally-friendly. Conventional methods for shipping goods also do not allow a SDA to choose environmentally-friendly shipping options. Conventional methods for shipping goods also provides only a limited ability for a SDA to report or document environmentally-friendly shipping practices based on analysis of shipping alternatives using environmentally-friendly criteria. Finally, conventional methods for shipping goods ultimately encourage fewer goods to be shipped via environmentally-friendly alternatives.

It would be desirable, therefore, if a method for environmentally-friendly shipping could be provided that would use environmental criteria in analyzing shipping options. It would also be desirable if such a method could be provided that would identify and present environmentally-friendly shipping options to a SDA. It would be further desirable if such a method could be provided that would allow a SDA to choose environmentally-friendly shipping options. It would be still further desirable if such a method and apparatus could be provided that would allow a SDA to report or document environmentally-friendly shipping practices based on an analysis of shipping alternatives using environmentally-friendly criteria. It would also be desirable if such a method and apparatus could be provided that would encourage a SDA to ship more goods via environmentally-friendly alternatives.

### Advantages of the Preferred Embodiments of the Invention

Accordingly, it is an advantage of the preferred embodiments of the invention claimed herein to provide a method for environmentally-friendly shipping that is adapted to use environmental criteria in analyzing shipping options. It is also an advantage of the preferred embodiments of the invention to provide such a method that presents environmentally-friendly shipping options to a shipping decision authority (“SDA”). It is another advantage of the preferred embodiments of the invention to provide such a method that allows a SDA to choose shipping options that minimize adverse environmental impacts and energy consumption. It is still another advantage of the preferred embodiments of the invention to provide such a method that allows a SDA to report or document the energy and/or environmental performance of shipping practices based on an analysis of shipping alternatives using energy and/or environmental performance criteria. It is yet another advantage of the preferred embodiments of the invention to provide such a method that encourages a SDA to ship more goods via alternatives that minimize adverse environmental impacts and energy consumption.

Additional advantages of the preferred embodiments of the invention will become apparent from an examination of the drawings and the ensuing description.

### Explanation of Technical Terms

As used herein, the terms “shipping decision authority” and “SDA” refer to any shipper, retail consumer, freight forwarder, consolidator, carrier or similar individuals or entities involved in a decision relating to the shipment of goods, products or freight. The terms “shipping decision authority” and “SDA” include without limitation, any operator of one or more transportation modes and any combination of operators across the logistics chain.

As used herein, the term “environmentally-friendly” refers to having a favorable impact on any one or more environmental impact measures, including without limitation, energy conservation, alternative energy choice, emissions reduction, adverse environmental impact mitigation or avoidance, human health impact mitigation or avoidance, and other impacts that reduce harm to human health and the environment.

### SUMMARY OF THE INVENTION

The invention comprises a method for environmentally-friendly shipping including requesting a shipment of goods, identifying available shipping options, analyzing the available shipping options, presenting the available shipping options, selecting one of the available shipping options and shipping the shipment of goods via the selected available shipping option. The method also includes considering one or more environmental impact measures.

### BRIEF DESCRIPTION OF THE DRAWINGS

The presently preferred embodiments of the invention are illustrated in the accompanying drawings, in which like reference numerals represent like parts throughout, and in which:

FIG. 1 is a flow chart of the preferred method for environmentally-friendly shipping in accordance with the present invention.

FIG. 2 is a flow chart of a first alternative embodiment of the method for environmentally-friendly shipping in accordance with the present invention.

FIG. 3 is a flow chart of a second alternative embodiment of the method for environmentally-friendly shipping in accordance with the present invention.

FIG. 4 is a flow chart of a third alternative embodiment of the method for environmentally-friendly shipping in accordance with the present invention.

FIG. 5 is a flow chart of a fourth alternative embodiment of the method for environmentally-friendly shipping in accordance with the present invention.

### DESCRIPTION OF PREFERRED EMBODIMENTS OF THE INVENTION

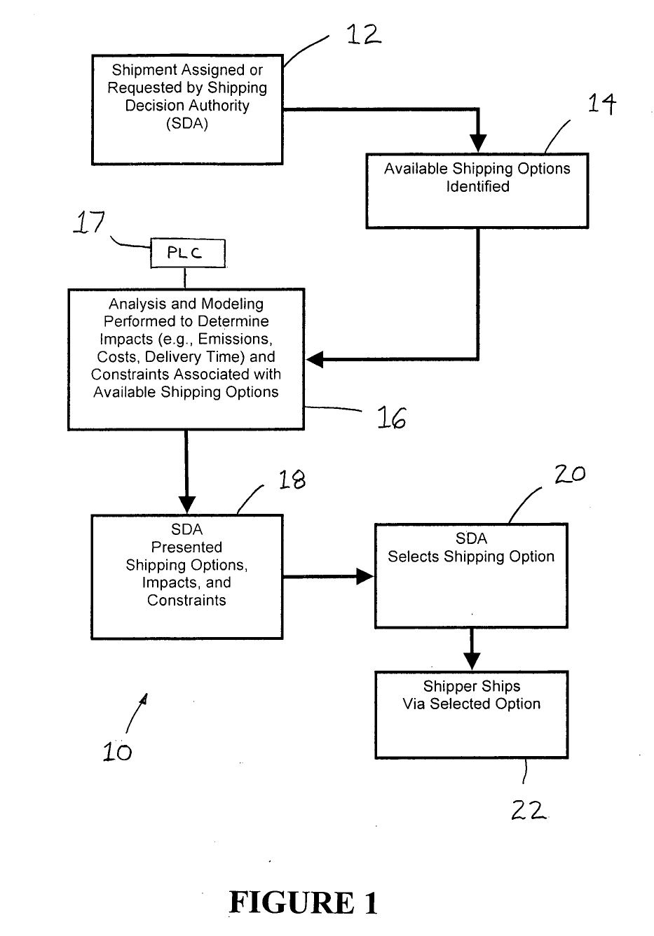

Referring now to the drawings, the preferred embodiments of the method for environmentally-friendly shipping are illustrated in FIGS. 1 through 5. As shown in FIGS. 1 through 5, the preferred embodiments of the method for environmentally-friendly shipping are adapted to directly integrate environmental objectives into shipping decisions and to make such environmentally-friendly shipping options available to a shipping decision authority (“SDA”). The preferred embodiments of the invention provide a SDA with the ability to make shipping choices based on environmental criteria. In addition, the preferred embodiments of the invention apply to a plurality of different types of customers, including retail consumers, distributors, producers, suppliers, wholesalers, and others along the entire supply-distribution network.

The preferred embodiments of the invention apply to a plurality of different types of environmental impacts, including air emissions, energy conservation, alternative energy choice, water pollution, land pollution, solid waste, hazardous waste and the like. The preferred embodiments of the invention also apply to a plurality of different forms of purchasing, including online purchasing, catalog purchasing, in-store purchasing and the like. Further, the preferred embodiments of the invention apply regardless of whether any environmental credits are generated by a SDA. Still further, the preferred embodiments of the invention may be tailored to provide, without limitation, (i) customer selection of an environmentally-friendly shipping option, (ii) shipper suggestion of an environmentally-friendly shipping option, and (iii) shipper requirement of an environmentally-friendly shipping option. In addition, the one or more environmental impact measures considered in the preferred method for environmentally-friendly shipping may be considered, without limitation, in the request for a shipment of goods, in the identification of available shipping options, in the analysis or modeling of the available shipping options, in the presentation of the available shipping options, in the selection of one of the available shipping options and/or in the shipment of the goods via the selected available shipping option.

Referring now to FIG. 1, a flow chart of the preferred method for environmentally-friendly shipping in accordance with the present invention is illustrated. As shown in FIG. 1, the preferred method for environmentally-friendly shipping is designated generally by reference numeral 10. The preferred method for environmentally-friendly shipping 10 comprises commencing or requesting a shipment of goods as shown in box 12. Preferably, a shipment of goods may be commenced by a SDA requesting another to ship goods to the SDA, such as in the case of a retail consumer. Alternatively, a shipment of goods may be commenced by a SDA instructing the shipment of goods to another, such as in the case of a manufacturer shipping goods to its distributor. In the preferred method for environmentally-friendly shipping 10, the amount and type of goods to be shipped and the location to which the goods are to be shipped are identified. It is contemplated within the scope of the invention that a shipment of goods may be commenced by a SDA by telephone, via the Internet, in writing, in person or any other suitable means for commencing a shipment of goods. It is also contemplated within the scope of the invention that one or more environmental impact measures may be considered in connection with the commencement of a shipment of goods.

Referring still to FIG. 1, the preferred method for environmentally-friendly shipping 10 identifies feasible or available shipping options as shown in box 14. Preferably, available shipping options are determined on the basis of factors such as the type and number of goods, the origin or location of the goods, the destination of goods and the like. It is contemplated within the scope of the invention, however, that feasible or available shipping options may be determined on the basis of any suitable criteria including, without limitation, one or more environmental impact measures.

Still referring to FIG. 1, the preferred method for environmentally-friendly shipping 10 also comprises analyzing and modeling the available shipping options identified in box 14 in order to determine the environmental impact of different modes for shipping the goods as shown in box 16. Preferably, a plurality of environmental inpacts are analyzed and modeled, including without limitation, energy conservation, alternative energy choice, emissions reduction, environmental impact mitigation or avoidance or human health impact mitigation or avoidance, and other impacts that reduce harm to human health and the environment. The preferred method for environmentally-friendly shipping 10 produces environmental impact information that may be balanced against economics, reliability, and delivery time criteria, which may in turn inform inventory decisions.

Still referring to FIG. 1, the analysis and modeling shown in box 16 preferably incorporates a variety of optimization algorithms that may be implemented on a microprocessor such as PLC 17. The preferred method for environmentally-friendly shipping 10 is adapted to combine attributes of the shipping network (including transportation modes), attributes of network segments (including cost, delivery time, and environmental attributes), and attributes of nodes (including intermodal transfer facilities) to determine shipping alternatives. The preferred method for environmentally-friendly shipping 10, therefore, produces a more extensive selection of shipping options, including options that perform better on environmental and energy measures. It is contemplated within the scope of the invention, however, that any other suitable analysis and/or modeling may be used to determine and identify environmentally-friendly shipping options.

Referring still to FIG. 1, the preferred method for environmentally-friendly shipping 10 involves the application of optimization algorithms and techniques to identify shipping methods that move goods from origin to destination in ways that minimize adverse environmental impacts given other system and decision-making constraints. Thus, the preferred method for environmentally-friendly shipping 10 focuses on fundamental logistic choices in the shipping network and allows users to satisfy certain goals. The preferred method for environmentally-friendly shipping 10 allows users to identify shipping routes, modes, and methods that are feasible and practical, and yet meet environmental objectives, including objectives representing any single or multiple set of environmental impacts (such as carbon dioxide emissions, sulfur dioxides emissions, nitrogen oxides emissions, particulate matter emissions, hazardous air pollutant emissions, water pollution, soil pollution, energy consumption, etc.). Preferably, these objectives are met in the context of other system and decision constraints, such as cost, delivery time, and reliability, as defined by a SDA.

Referring still to FIG. 1, the preferred method for environmentally-friendly shipping 10 is applied through an optimization process whereby information about the environmental attributes of the shipping network (such as geographic origin, destination, network segments, network nodes, and transportation modes) can be used to identify shipping options to a SDA that minimize selected adverse environmental impacts. In the preferred embodiments of the invention, origins and destinations can describe any subset of a shipment of goods (e.g., from factory to distribution center, from distribution center to retail outlet, or from retail outlet to customer). Preferably, origins and destinations also refer to business-to-business and business-to-customer deliveries. It is also contemplated within the scope of the invention that business-to-business shipping may refer to internal shipping decisions made by a single company (e.g., decisions that a company may make to move freight from factories to distribution centers to retail locations).

Still referring to FIG. 1, the preferred method for environmentally-friendly shipping 10 is indifferent to the specific type of optimization algorithm that is used to calculate and minimize the adverse environmental impacts of shipping goods. In addition, the preferred method for environmentally-friendly shipping 10 integrates the optimization of environmental factors into shipping decisions for a SDA in such a way as to give the SDA a choice between traditional shipping methods and environmentally-friendly shipping methods.

Still referring to FIG. 1, in the preferred method for environmentally-friendly shipping 10, the available shipping options identified in box 14 and analyzed or modeled in box 16 are presented to a SDA as shown in box 18. Preferably, the shipping options provided to the SDA include information regarding the adverse environmental impacts of the different options. For example, the SDA may be presented the following three alternative shipping decisions: (1) an alternative that minimizes delivery time, but perhaps at a high cost and a high adverse environmental impact; (2) an alternative that minimizes costs, but perhaps at a longer delivery time and high adverse environmental impact; and (3) an alternative that minimizes adverse environmental impacts, but perhaps at a higher cost and longer delivery time. It is contemplated within the scope of the invention that shipping options may exist and may be presented to the SDA that achieve multiple objectives simultaneously. It is also contemplated within the scope of the invention that the SDA may be presented with multiple alternatives that result in different levels of environmental impact. It is further contemplated within the scope of the invention that the SDA may be presented with the available shipping options via any suitable means including, without limitation, telephone, the Internet, written document, and the like.

Still referring to FIG. 1, in the preferred method for environmentally-friendly shipping 10, the SDA then selects a desired shipping option as shown in box 20. Preferably, the SDA selects the desired shipping option from the shipping options presented in box 18. It is contemplated within the scope of the invention that the SDA may select the desired shipping option via any suitable means including, without limitation, telephone, the Internet, written document, and the like. It is also contemplated within the scope of the invention that one or more environmental impact measures are considered in the selection of the desired shipping option. Finally, in the preferred method for environmentally-friendly shipping 10, a shipper ships the goods via the shipping option selected by the SDA as shown in box 22. Preferably, one or more environmental impact measures are considered in the shipment of the goods.

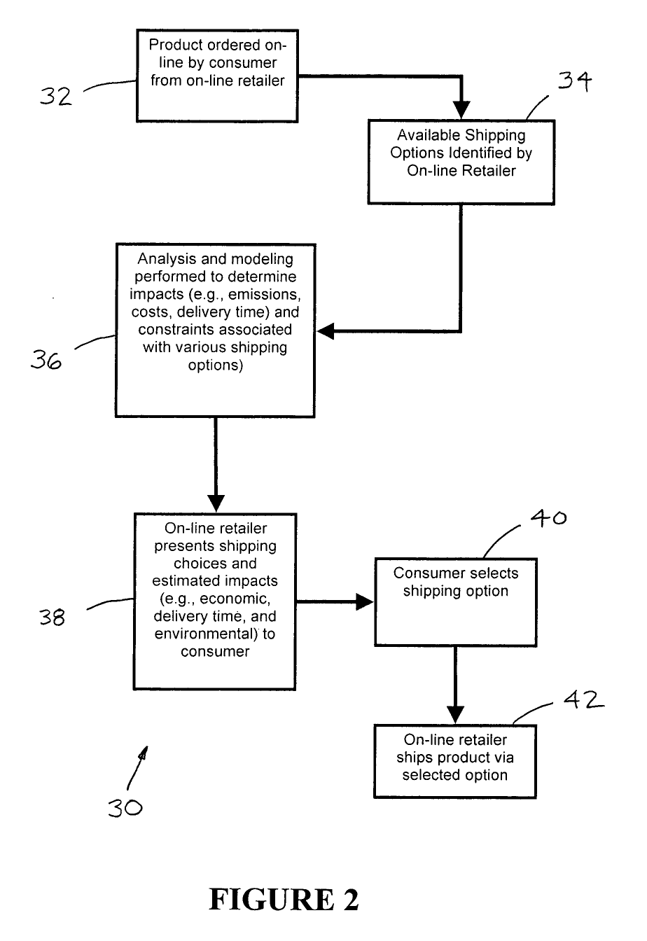

Referring now to FIG. 2, a flow chart of a first alternative embodiment of the method for environmentally-friendly shipping in accordance with the present invention is illustrated. More particularly, the preferred method for environmentally-friendly shipping is designated generally by reference numeral 30. In the preferred method for environmentally-friendly shipping 30, the SDA is an on-line consumer requesting a shipment of goods from an on-line retailer. As shown in FIG. 2, in the preferred method for environmentally-friendly shipping 30, the on-line consumer requests a shipment of goods from an on-line retailer as shown in box 32, the available shipping options are identified by the on-line retailer as shown in box 34, the available shipping options are analyzed or modeled as shown in box 36, the analyzed or modeled available shipping options are presented to the on-line consumer by the on-line retailer as shown in box 38, the on-line consumer selects one of the shipping options as shown in box 40 and the on-line retailer ships the goods to the on-line consumer via the selected shipping option as shown in box 42.

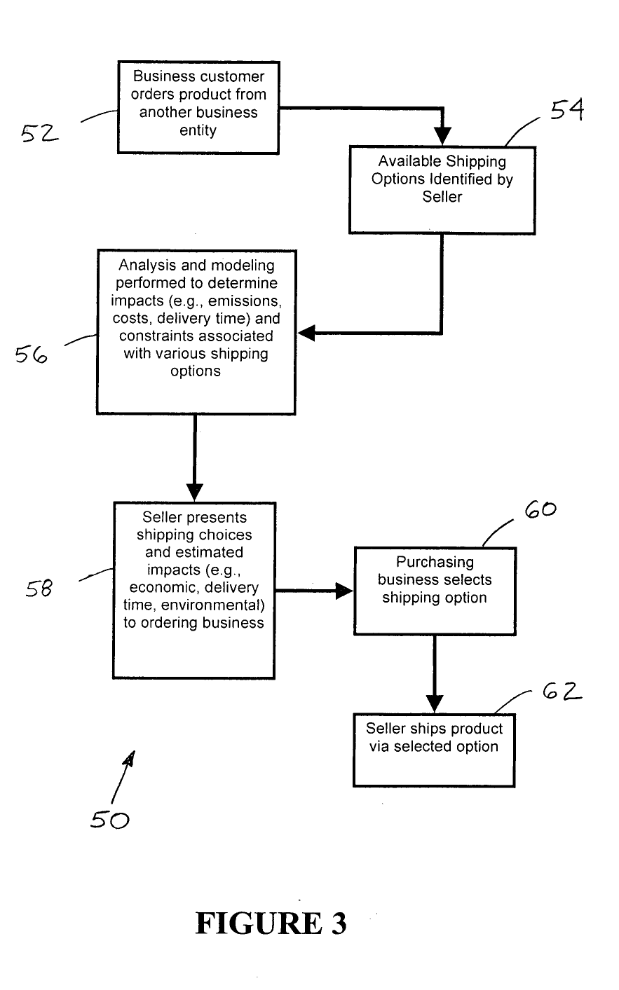

Referring now to FIG. 3, a flow chart of a second alternative embodiment of the method for environmentally-friendly shipping in accordance with the present invention is illustrated. More particularly, the preferred method for environmentally-friendly shipping is designated generally by reference numeral 50. In the preferred method for environmentally-friendly shipping 50, the SDA is a business customer requesting a shipment of goods from another business entity. As shown in FIG. 3 , in the preferred method for environmentally-friendly shipping 50, the business customer requests a shipment of goods from another business entity as shown in box 52, the available shipping options are identified by the seller as shown in box 54, the available shipping options are analyzed or modeled as shown in box 56, the analyzed or modeled available shipping options are presented to the business customer by the seller as shown in box 58, the business customer selects one of the shipping options as shown in box 60 and the seller ships the goods to the business customer via the selected shipping option as shown in box 62.

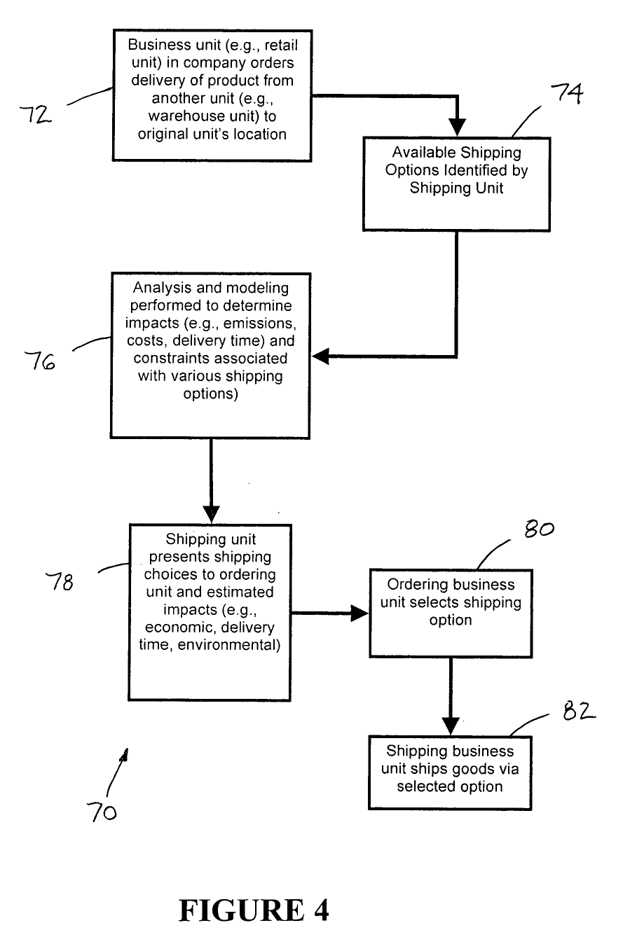

Referring now to FIG. 4, a flow chart of a third alternative embodiment of the method for environmentally-friendly shipping in accordance with the present invention is illustrated. More particularly, the preferred method for environmentally-friendly shipping is designated generally by reference numeral 70. In the preferred method for environmentally-friendly shipping 70, the SDA is a unit of a business requesting a shipment of goods from another unit (i.e., the shipping unit) of the same business. As shown in FIG. 4, in the preferred method for environmentally-friendly shipping 70, the unit of a business requests a shipment of goods from the shipping unit of the business as shown in box 72, the available shipping options are identified by the shipping unit as shown in box 74, the available shipping options are analyzed or modeled as shown in box 76, the analyzed or modeled available shipping options are presented to the business unit by the shipping unit as shown in box 78, the business unit selects one of the shipping options as shown in box 80 and the shipping unit ships the goods to the business unit via the selected shipping option as shown in box 82.

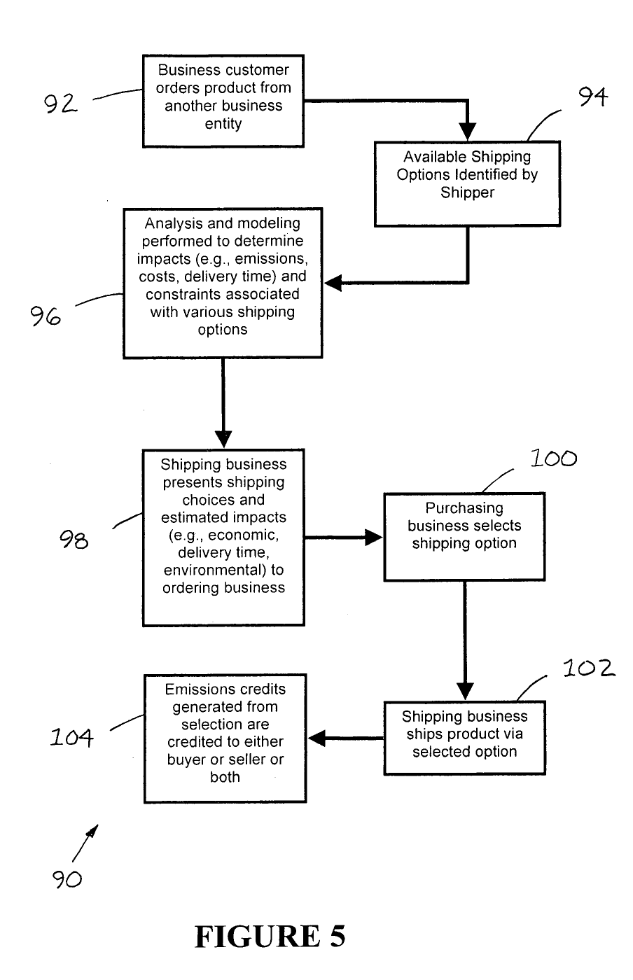

Referring now to FIG. 5, a flow chart of a fourth alternative embodiment of the method for environmentally-friendly shipping in accordance with the present invention is illustrated. More particularly, the preferred method for environmentally-friendly shipping is designated generally by reference numeral 90. In the preferred method for environmentally-friendly shipping 90, the SDA is business customer requesting a shipment of goods from another business entity (i.e., the shipper). As shown in FIG. 5, in the preferred method for environmentally-friendly shipping 90, the business customer requests a shipment of goods from another business entity as shown in box 92, the available shipping options are identified by the shipper as shown in box 94, the available shipping options are analyzed or modeled as shown in box 96, the analyzed or modeled available shipping options are presented to the business customer by the shipper as shown in box 98, the business customer selects one of the shipping options as shown in box 100 and the shipper ships the goods to the business customer via the selected shipping option as shown in box 102. In addition, in the preferred embodiments of the method for environmentally-friendly shipping 90, if the shipping option selected by the SDA results in emissions reduction credits, as sanctioned by a body governing the generation of such credits, then the method identifies those credits and credits them to either the buyer or the seller or both as shown in box 104.

In operation, several advantages of the invention are achieved. For example, the preferred embodiments of the invention claimed herein provide a method for environmentally-friendly shipping that is adapted to use environmental criteria in analyzing shipping options. The preferred embodiments of the invention also provide a method that presents environmentally-friendly shipping options to a shipping decision authority (“SDA”). The preferred embodiments of the invention further provide a method that allows a SDA to choose shipping options that minimize adverse environmental impacts and energy consumption. The preferred embodiments of the invention still further provide a method that allows a SDA to report or document the energy and/or environmental performance of shipping practices based on an analysis of shipping alternatives using energy and/or environmental performance criteria. In addition, the preferred embodiments of the invention provide a method that encourages a SDA to ship more goods via alternatives that minimize adverse environmental impacts and energy consumption.

What is claimed is:

1. A method for environmentally-friendly shipping, said method comprising:
a. requesting a shipment of goods;
b. identifying available shipping options;
c. analyzing the available shipping options;
d. presenting the available shipping options;
e. selecting one of the available shipping options;
f. shipping the shipment of goods via the selected available shipping option wherein the available shipping options are analyzed using one or more environmental impact measures and wherein steps a. through e. are implemented using a microprocessor.

2. The method for environmentally-friendly shipping of claim 1, wherein the process of identifying available shipping options involves determination of environmental impacts from such shipping options.

3. The method for environmentally-friendly shipping of claim 2, wherein the environmental impacts from such shipping options include a determination of pollution emissions that result from the alternative shipping options.

4. The method for environmentally-friendly shipping of claim 2, wherein the environmental impacts from such shipping options include a determination of total mass emissions produced during the shipping process.

5. The method for environmentally-friendly shipping of claim 2, wherein the environmental impacts from such shipping options include a determination of mass emissions per distance produced during the shipping process.

6. The method for environmentally-friendly shipping of claim 2, wherein the environmental impacts from such shipping options are calculated using microprocessor-based programming that applies environmental information about a shipping mode and a shipping route.

7. The method for environmentally-friendly shipping of claim 1, wherein the available shipping options are analyzed through the application of microprocessor-based programming, including network optimization modeling, linear programming, and non-linear programming in order to determine the environmental impacts of the available shipping options.

8. The method for environmentally-friendly shipping of claim 1, wherein the identification of available shipping options is determined by a shipping decision authority.

9. The method for environmentally-friendly shipping of claim 1, wherein the analysis of available shipping options is performed by microprocessor-based programming using shipping mode characteristics to compare environmental impacts among identified shipping options.

10. The method for environmentally-friendly shipping of claim 1, wherein the analysis of available shipping options is performed by microprocessor-based programming using information about shipping methods to compare environmental impacts among identified shipping options.

11. The method for environmentally-friendly shipping of claim 1, wherein the analysis of available shipping options is performed by microprocessor-based programming using information about shipping routes to compare environmental impacts among identified shipping options.

12. The method for environmentally-friendly shipping of claim 1, wherein the analysis of available shipping options is performed by microprocessor-based programming using information about the shipper to compare environmental impacts among identified shipping options.

13. The method for environmentally-friendly shipping of claim 1, wherein the potential environmental impacts of each of the available shipping options are presented in order to provide the shipping decision authority comparative information on the potential environmental impacts of each of the available shipping options.

14. The method for environmentally-friendly shipping of claim 1, wherein the presentation of available shipping options and their environmental impacts is provided by microprocessor-based output.

15. The method for environmentally-friendly shipping of claim 1, wherein a shipping decision authority is allowed to select from the available shipping options.

16. The method for environmentally-friendly shipping of claim 1, wherein a consumer requests a shipment of goods via the Internet.

17. The method for environmentally-friendly shipping of claim 1, wherein emissions credits are generated through the environmentally-friendly shipping option.
